(19) United States
(12) Patent Application Publication
(10) Pub. No.: US 2014/0125636 A1
(43) Pub. Date: May 8, 2014

(54) ELECTRONIC PEN DATA INPUT SYSTEM AND ELECTRONIC PEN DATA INPUT METHOD USING THE SAME

(71) Applicant: SAMSUNG ELECTRO-MECHANICS CO., LTD., Suwon (KR)

(72) Inventors: Yong Il KWON, Suwon (KR); Tah Joon PARK, Suwon (KR); Seung Chul PYO, Suwon (KR)

(73) Assignee: SAMSUNG ELECTRO-MECHANICS CO., LTD., Suwon (KR)

(21) Appl. No.: 13/751,898

(22) Filed: Jan. 28, 2013

(30) Foreign Application Priority Data
Nov. 5, 2012 (KR) 10-2012-0124448

(51) Int. Cl. G06F 3/0354

(52) U.S. Cl. CPC G06F 3/03545
USPC 345/179

(57) ABSTRACT

There are provided an electronic pen data input system and an electronic pen data input method using the same. The electronic pen data input system includes: an electronic pen including an accelerometer sensor to provide acceleration information corresponding to movement thereof; and a portable communications terminal calculating movement information of the electronic pen using the acceleration information of the electronic pen and compensating for a noise input in the movement information to determine a handwriting data input.

### CROSS-REFERENCE TO RELATED APPLICATIONS

This application claims the priority of Korean Patent Application No. 10-2012-0124448 filed on Nov. 5, 2012, in the Korean Intellectual Property Office, the disclosure of which is incorporated herein by reference.

### BACKGROUND OF THE INVENTION

1. Field of the Invention

The present invention relates to an electronic pen data input system using an electronic pen having a simplified configuration using an accelerometer sensor, and an electronic pen data input method using the same.

2. Description of the Related Art

In accordance with the development of portable communications terminals, various portable communications terminals have been developed. These portable communications terminals such as cellular phones, tablet computers, and the like have tended to provide high degrees of processing performance together with portability. In addition, display modules of the portable communications terminals have been gradually developed so as to satisfy demands for high resolution and desired size.

As data input methods utilized in portable communications terminals, a method of directly receiving user data input through a touch screen, or the like, a method of receiving user data input using a predetermined electronic pen, and the like, have been used. In particular, the method of performing a data input using an electronic pen allows for more accurate data input as compared with the touch input method by hands.

However, an electronic pen according to the related art has a limitation in that it requires an excessive amount of sensors, and the like, for accuracy of input. In addition, the electronic pen according to the related art has a limitation in that it has a relatively large size, thereby decreasing portability of the portable communications terminal.

The following Related Art Documents (Patent Documents), related to electronic pen data input technology, do not overcome the above-mentioned limitations of the data input technology using the electronic pen.

### RELATED ART DOCUMENT

(Patent Document 1) Korean Patent No. 10-0408518
(Patent Document 2) Japanese Patent Laid-Open Publication No. 1996-328738

### SUMMARY OF THE INVENTION

An aspect of the present invention provides an electronic pen data input system capable of improving portability by using an electronic pen having a simplified configuration using an accelerometer sensor and performing a data input without touching a portable communications terminal, and an electronic pen data input method using the same.

According to an aspect of the present invention, there is provided an electronic pen data input system including: an electronic pen including an accelerometer sensor to provide acceleration information corresponding to movement thereof; and a portable communications terminal calculating movement information of the electronic pen using the acceleration information of the electronic pen and compensating for a noise input in the movement information to determine a handwriting data input.

The electronic pen may include: a triaxial accelerometer sensor sensing a change in acceleration based on triaxial coordinates of the electronic pen; and a controlling unit setting a reference point represented by the triaxial coordinates and generating the acceleration information using the change in acceleration sensed by the triaxial accelerometer sensor due to the movement of the electronic pen.

The controlling unit may allow information regarding the reference point to be included in the acceleration information and provides the acceleration information to the portable communications terminal.

The electronic pen may further include a switching unit sensing an external pressing input, and the controlling unit may generate the acceleration information when the pressing input is sensed by the switching unit.

The electronic pen may further include a pressure-sensitive sensor disposed at one end thereof and sensing an amount of pressure provided from the outside, and the controlling unit may generate the acceleration information when pressure of a threshold value or more is sensed by the pressure-sensitive sensor.

The portable communications terminal may integrate the acceleration information provided from the electronic pen to calculate a movement path of the electronic pen.

The portable communications terminal may allow a specific position of a display unit thereof to correspond to the reference point to thereby determine the handwriting data input.

The portable communications terminal may receive the reference point and a ratio determining point from the electronic pen and allow a relationship between the reference point and the ratio determining point to correspond to a portion of a size of the display unit of the portable communications terminal to thereby determine an output ratio of the handwriting data input.

According to another aspect of the present invention, there is provided an electronic pen data input method performed by an electronic pen including an accelerometer sensor and interworking with a portable communications terminal to generate a handwriting data input, the electronic pen data input method including: setting a reference point; detecting a change in acceleration on triaxial coordinates based on the set reference point; and generating acceleration information including the change in acceleration and information regarding the reference point.

The generating of the acceleration information may include generating the acceleration information from the change in acceleration when a predetermined amount of pressure is sensed from the outside.

The electronic pen data input method may further include integrating the generated acceleration information to calculate movement information of the electronic pen.

The electronic pen data input method may further include compensating for noise information in the generated movement information to determine the handwriting data input.

According to another aspect of the present invention, there is provided an electronic pen data input method performed by a portable communications terminal interworking with an electronic pen including an accelerometer sensor to generate a handwriting data input, the electronic pen data input method including: receiving information regarding a reference point represented by triaxial coordinates and acceleration information from the electronic pen; determining the handwriting data input generated by movement of the electronic pen using the acceleration information; and displaying the handwriting data input by allowing a specific position of a display unit of the portable communications terminal to correspond to the reference point.

The determining of the handwriting data input may include: integrating the acceleration information to calculate a movement path of the electronic pen; and compensating for a noise input in the calculated movement information to determine the handwriting data input.

The compensating of the noise input may include determining the acceleration information, in which a coordinate value corresponding to a height in the triaxial coordinates is equal to or greater than a threshold value, as the noise input.

The displaying of the handwriting data input may include: receiving a ratio determining point represented by the triaxial coordinates from the electronic pen; and determining the handwriting data input by allowing a relationship between the reference point and the ratio determining point to correspond to a portion of a size of the display unit of the portable communications terminal.

The determining of the handwriting data input may include: determining a display ratio by allowing a distance between the reference point and the ratio determining point to correspond to a portion of a length of the display unit of the portable communications terminal; and determining the handwriting data input by reflecting the determined display ratio.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a reference diagram illustrating an example of an electronic pen data input system according to the related art;

FIG. 2 is a reference diagram illustrating another example of an electronic pen data input system according to the related art;

FIG. 3 is a reference diagram illustrating an example of an electronic pen data input system according to an embodiment of the present invention;

FIG. 4 is a configuration diagram illustrating an example of an electronic pen according to an embodiment of the present invention;

FIG. 5 is a reference diagram illustrating a configuration of an electronic pen according to an embodiment of the present invention;

FIG. 6 is a reference diagram illustrating another configuration of an electronic pen according to an embodiment of the present invention;

FIG. 7 is a configuration diagram illustrating an example of a portable communications terminal according to an embodiment of the present invention;

FIG. 8 is a flowchart illustrating an example of an electronic pen data input method according to an embodiment of the present invention;

FIGS. 9 and 10 are flowcharts illustrating for describing other examples of an electronic pen data input method according to an embodiment of the present invention; and

FIG. 11 is a reference diagram illustrating an input of an electronic pen and a display ratio of a portable communications terminal.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of components may be exaggerated for clarity, and the same reference numerals will be used throughout to designate the same or like components.

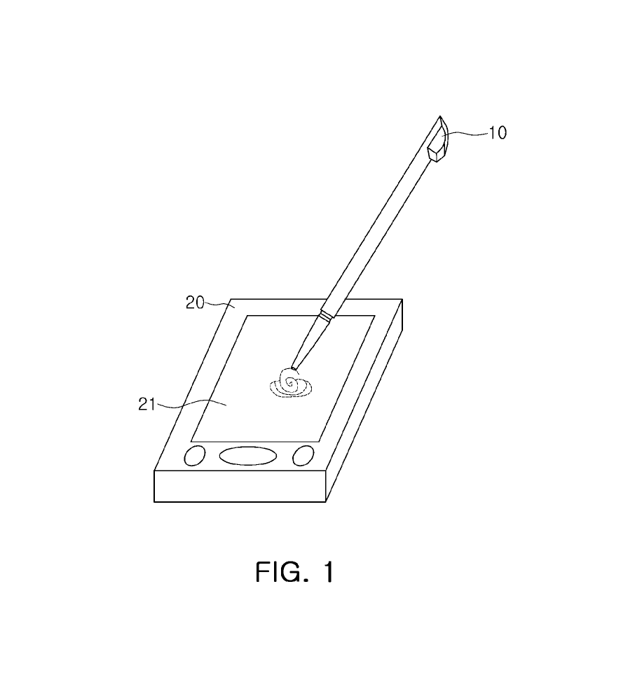

FIG. 1 is a reference diagram illustrating an example of an electronic pen data input system according to the related art.

The example of the electronic pen data input system shown in FIG. 1 relates to a scheme using a magnet.

In this scheme, the magnet may be attached to a distal end of an electronic pen 10 to form a magnetic field. Therefore, in the case in which the electronic pen touches a surface of a capacitive touch panel 21 of a portable communications terminal 20, an electrical field is changed due to the magnetic field and a change amount is detected to perform a data input.

However, in the case of this scheme, since the magnetic field is expanded in a predetermined range, it is difficult to accurately determine the input, such that an erroneous data recognition rate is significantly high. In addition, the input should only be performed on the touch panel 21 of the portable communications terminal.

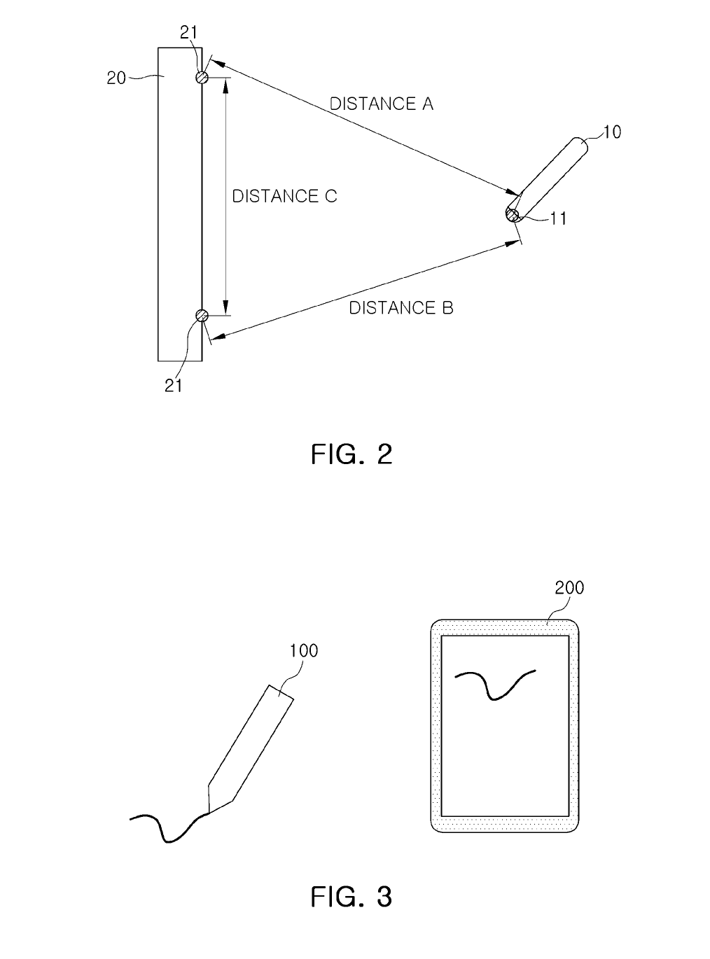

FIG. 2 is a reference diagram illustrating another example of an electronic pen data input system according to the related art. Another example of the electronic pen data input system shown in FIG. 2 relates to a scheme using an ultrasonic sensor.

That is, in this scheme, an ultrasonic transmitting sensor 11 is attached to a distal end of an electronic pen 10, and two ultrasonic receiving sensors 21 are provided in a portable communications terminal 20 to determine a position of the electronic pen through triangulation using distances (distances A to C) between the respective ultrasonic sensors.

This scheme has an advantage in that a data input may be performed without touching the portable communications terminal 20, but has a limitation in that a plurality of ultrasonic sensors 11 and 21 are required and at least two ultrasonic sensors are also required in the portable communications terminal 20. Therefore, due to the above-mentioned limitation, it is difficult to apply this scheme to various portable communications terminals.

Hereinafter, an electronic pen data input system according to an embodiment of the present invention and an electronic pen data input method according to an embodiment of the present invention will be described in detail with reference to FIGS. 3 through 11.

FIG. 3 is a reference diagram illustrating an example of an electronic pen data input system according to an embodiment of the present invention.

As shown in FIG. 3, an electronic pen data input system according to the embodiment of the present invention may include an electronic pen 100 and a portable communications terminal 200.

Although the electronic pen 100 and the portable communications terminal 200 form a communications environment therebetween by a wireless communications method in this embodiment of FIG. 3, the electronic pen 100 and the portable communications terminal 200 may communicate with each other by a wired communications method according to embodiments of the present invention. For example, it is obvious that a scheme of directly connecting a flexible cable (not shown) provided at a distal end of the electronic pen 100 to the portable communications terminal 200 to perform wired communications may be implemented.

The electronic pen 100 may include an accelerometer sensor to provide acceleration information corresponding to a movement thereof.

The portable communications terminal 200 may calculate movement information of the electronic pen 100 using the acceleration information of the electronic pen 100 and compensate for a noise input in the calculated movement information to determine a handwriting data input.

As shown in FIG. 3, according to the embodiment of the present invention, the electronic pen 100 may perform the data input using any plane. That is, according to the embodiment of the present invention, the data input may be performed on any plane as well as a touch panel of the portable communications terminal 20. The reason is that since the electronic pen 100 according to the embodiment of the present invention includes the accelerometer sensor, a movement path thereof may be calculated using the accelerometer sensor.

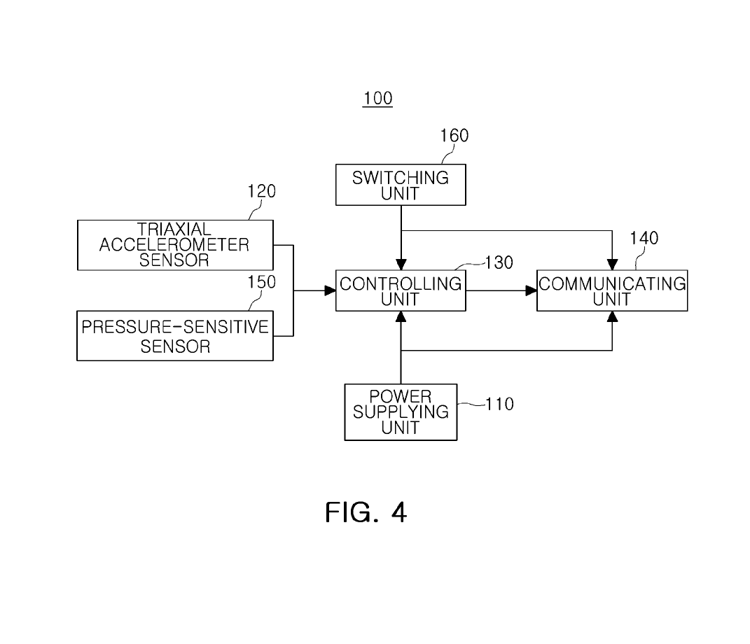

The electronic pen 100 and the portable communications terminal 200 will be described below in more detail with reference to FIGS. 4 through 11.

FIG. 4 is a configuration diagram illustrating an example of the electronic pen according to an embodiment of the present invention.

Referring to FIG. 4, the electronic pen 100 may include a power supplying unit 110, a triaxial accelerometer sensor 120, a controlling unit 130, and a communicating unit 140. In the embodiment of the present invention, the electronic pen 100 may further include at least one of a pressure-sensitive sensor 150 and a switching unit 160.

The power supplying unit 110 may supply power to components of the electronic pen 100.

The triaxial accelerometer sensor 120 may sense a change in acceleration on triaxial coordinates of the electronic pen 100. The triaxial accelerometer sensor 120 may provide data on the sensed change in acceleration on the triaxial coordinates to the controlling unit 130.

The controlling unit 130 may control other components of the electronic pen 100.

In the embodiment of the present invention, the controlling unit 130 may generate acceleration information using the data on the change in acceleration sensed by the triaxial accelerometer sensor 120 due to the movement of the electronic pen 100.

In the embodiment of the present invention, the controlling unit 130 may set information regarding a reference point. The reference point means a specific point represented by the triaxial coordinates. That is, since the data sensed by the accelerometer sensor 120 is an amount of change in acceleration, a specific reference point is required in order to calculate a movement line of the electronic pen 100 from the acceleration. Therefore, when a specific point is set as the reference point, the controlling unit 130 may set a triaxial point corresponding to the set reference point as information regarding the reference point. For example, the controlling unit 130 may set a specific direction as an X axis, set a direction perpendicular to the X axis as a Y axis, set a direction perpendicular to a plane generated by the X and Y axes as a Z axis, and generate acceleration information on the three axes.

In the embodiment of the present invention, the controlling unit 130 may allow information regarding the reference point to be included in the acceleration information and provide the acceleration information to the portable communications terminal 200. In the embodiment of the present invention, the acceleration information may include the data on the change in acceleration on the triaxial coordinates sensed by the triaxial accelerometer sensor 120 and the information regarding the reference point.

In the embodiment of the present invention, the controlling unit 130 may calculate the handwriting data input by the movement of the electronic pen 100 using the data on the change in acceleration sensed by the triaxial accelerometer sensor 120. That is, in the present embodiment, a process of calculating the handwriting data input of the electronic pen 100 from the acceleration information may be performed by the electronic pen 100 itself. However, according to another embodiment of the present invention, the process of calculating the handwriting data input of the electronic pen 100 from the acceleration information may also be performed by the portable communications terminal 200.

More specifically, the controlling unit 130 may calculate information regarding a movement distance of the electronic pen (hereinafter, referred to as movement information) from the acceleration information and compensate for noise in the calculated movement information to calculate handwriting data input information by the electronic pen 100.

Here, the acceleration information may be integrated to thereby be calculated as speed information. This may be calculated by the following Equation 1.

$$s = {v}_{0} t + \frac{1}{2} {at}^{2} \qquad [ Equation 1 ]$$

where S indicates a movement distance, V₀ indicates an initial speed, a indicates acceleration, and t indicates time. The above Equation 1 may be integrated to calculate a relationship between the acceleration and the speed and calculate the movement distance from the acceleration information using the relationship between the acceleration and the speed.

In general, in the case of performing a data input using an electronic pen, the electronic pen may be moved for movement between characters to be written, in addition to movement for a handwriting data input. According to the embodiment of the present invention, the movement of the electronic pen between the characters may be judged as noise input, such that compensation for deleting the noise input may be performed. For example, in the case in which a height axis (Z axis) is equal to or greater than a preset numerical value, the corresponding movement information may be determined to be noise.

The communicating unit 140 may communicate with the portable communications terminal 200.

In the embodiment of the present invention, the communicating unit 140 may form or maintain a communications session with the portable communications terminal 200 in a wireless communication scheme.

In another embodiment of the present invention, the communicating unit 140 may be connected to the portable communications terminal 200 in a wired communication scheme. In this case, the communicating unit 140 may be formed integrally with the power supplying unit 110 to receive power from the portable communications terminal 200 through a wired line.

The pressure-sensitive sensor 150, which is a sensor sensing an amount of pressure provided from the outside, may be provided at one end of the electronic pen 100. For example, the pressure-sensitive sensor 150 may be protruded at a distal end of the electronic pen 100 and sense pressure equal to or higher than a predetermined value in the case of performing the handwriting data input using the electronic pen 100. The controlling unit 130 may process the pressure provided from the outside as a valid input only in the case in which pressure of a threshold value or more is sensed by the pressure-sensitive sensor 150. For example, the controlling unit 130 may only accept acceleration data detected while the pressure of the threshold value or more is sensed by the pressure-sensitive sensor 150 as valid data to generate acceleration information.

The switching unit 160 may sense an external pressing input. For example, the switching unit 160 may be provided in any position of a body of the electronic pen 100 to sense the pressing input by a user's finger. The controlling unit 130 may process the external pressing input as a valid input only in the case in which the pressing input is sensed by the switching unit 160. For example, the controlling unit 130 may only accept acceleration data detected while the pressing input is sensed by the switching unit 160 as valid data to generate acceleration information.

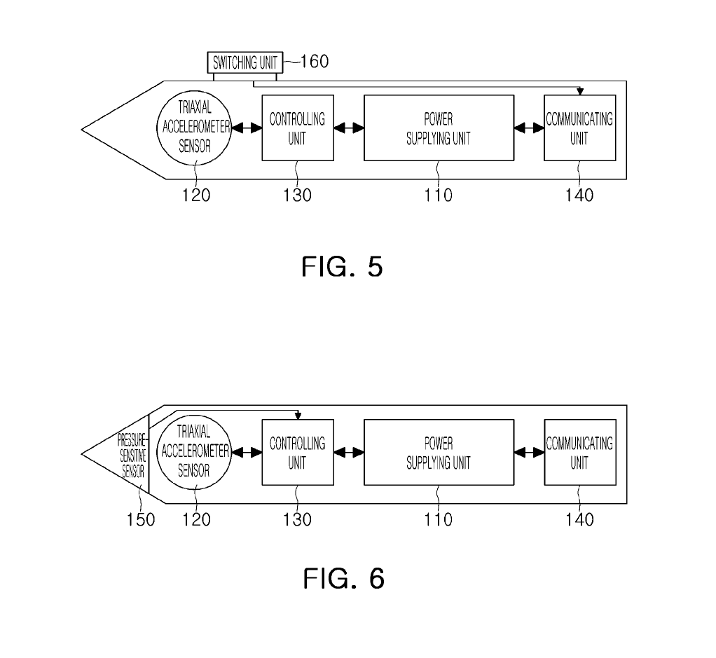

FIGS. 5 and 6 are reference diagrams illustrating one configuration and another configuration of an electronic pen according to an embodiment of the present invention.

FIG. 5 shows the electronic pen 100 including the switching unit 160; and FIG. 6 shows the electronic pen 100 including the pressure-sensitive sensor 150.

In one example of FIG. 5, the pressing input of the switching unit 160 is connected to the communicating unit 140. In this configuration, the acceleration information, or the like, may be transmitted to the portable communications terminal 200 only while the pressing input is present. However, as described above, the pressing input of the switching unit 160 may be provided to the controlling unit 130.

In another example of FIG. 6, the pressure-sensitive sensor 150 is provided at a distal end of the electronic pen 100. The pressure-sensitive sensor 150 may provide a sensed pressure value to the controlling unit 130, and the controlling unit 150 may determine the pressure value as a valid input only in the case in which the pressure value provided by the pressure-sensitive sensor 150 is equal to or higher than a predetermined value, as described above.

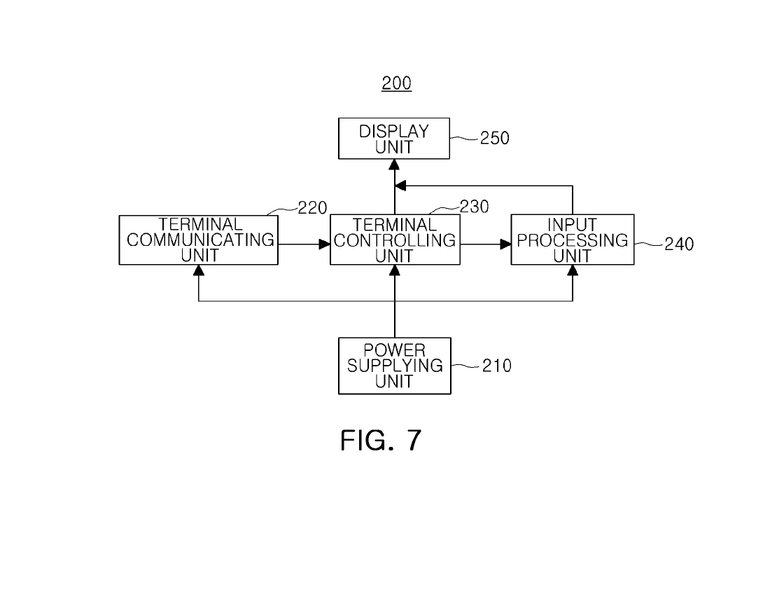

FIG. 7 is a configuration diagram illustrating an example of the portable communications terminal according to the embodiment of the present invention.

Referring to FIG. 7, the portable communications terminal 200 may include a power supplying unit 210, a terminal communicating unit 220, a terminal controlling unit 230, an input processing unit 240, and a display unit 250.

The power supplying unit 210 may supply power to components of the portable communications terminal 200.

The terminal communicating unit 220 may communicate with the electronic pen 100.

In the embodiment of the present invention, the terminal communicating unit 220 may form or maintain a communications session with the electronic pen 100 in a wireless communication scheme.

In another embodiment of the present invention, the terminal communicating unit 220 may be connected to the electronic pen 100 in a wired communication scheme. In this case, the terminal communicating unit 220 may be formed integrally with the power supplying unit 210 to provide the power to the electronic pen 100 through a wired line.

The terminal controlling unit 230 may control other components of the portable communications terminal 200.

In the embodiment of the present invention, when the terminal controlling unit 230 receives the acceleration information from the electronic pen 100, it may provide the acceleration information to the input processing unit 240.

The input processing unit 240 may determine the handwriting data input of the electronic pen 100 using the acceleration information.

In the embodiment of the present invention, the input processing unit 240 may calculate a movement path of the electronic pen 100 from the information regarding the reference point and the acceleration data included in the acceleration information and remove noise input in the calculated movement path to determine the handwriting data input of the electronic pen 100. Since this corresponds to the above description with reference to FIG. 4 and Equation 1, a detailed description thereof will be omitted.

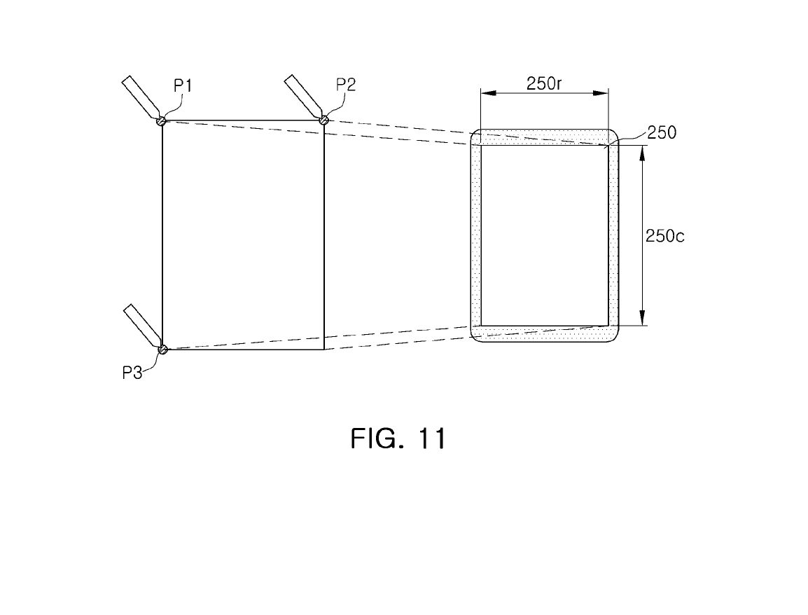

In the embodiment of the present invention, the input processing unit 240 may allow a specific position of the display unit 250 of the portable communications terminal 200 to correspond to the reference point received from the electronic pen 100, thereby determining the handwriting data input. Describing this in detail with reference to FIG. 11, P1 may be a reference point, and the input processing unit 240 may allow a left upper edge of the display unit 250 to correspond to P1. Therefore, the input processing unit 240 may allow the handwriting data input calculated based on the reference point to be displayed based on the left upper edge of the display unit 250.

In the embodiment of the present invention, the input processing unit 240 may determine a plane (input plane) on which the electronic pen 100 performs the handwriting data input and match the input plane to the display unit 250 to determine a display ratio of the handwriting data input using a ratio between the input plane and the display unit 250.

For example, the input processing unit 240 may receive the reference point and a ratio determining point from the electronic pen 100. Here, the ratio determining point may be a specific point for determining the plane (input plane) on which the electronic pen 100 performs the handwriting data input. In an example of FIG. 11, P1 may be the reference point, and P2 or P3 may be the ratio determining point. The ratio determining point may include at least one of a width determining point P2 and a length determining point P3. The input processing unit 240 may allow a relationship between the reference point and the ratio determining point to correspond to a portion of a size of the display unit 250 of the portable communications terminal 200, thereby determining an output ratio of the handwriting data input. In the example of FIG. 11, the input processing unit 240 may reflect a ratio between a distance between P1 and P2 and a width 250r of the display unit 250 to thereby determine the output ratio of the handwriting data input. Therefore, in the case in which the electronic pen 100 inputs a straight line from P1 to P2, the input processing unit 240 may display a straight line on edges of an upper surface of the display unit 250, that is, from a left upper edge of the display unit 250 to a right upper edge thereof.

The display unit 250 may display the handwriting data input of the electronic pen 100 by the input processing unit 240.

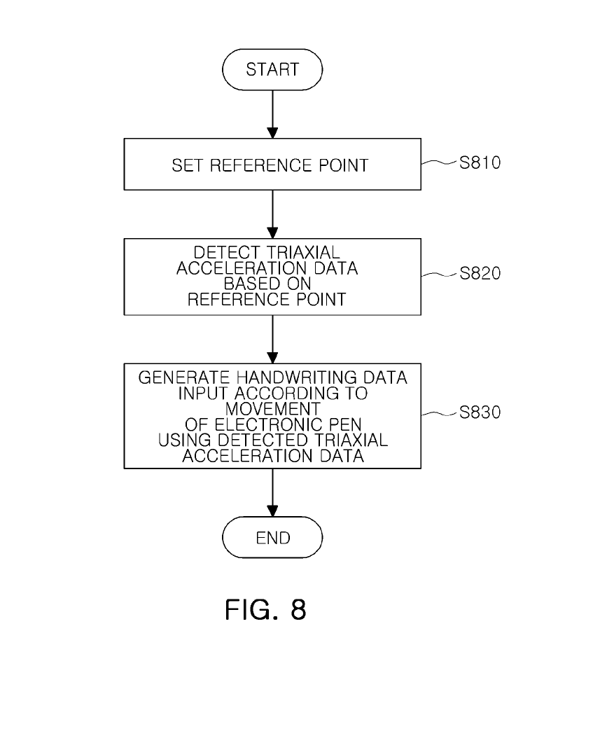

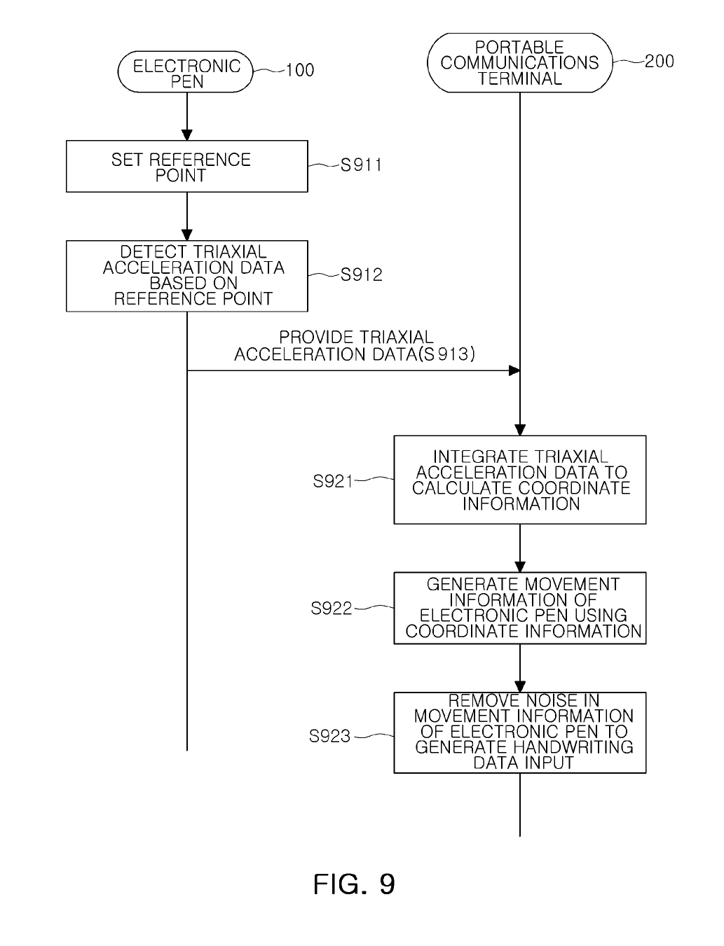

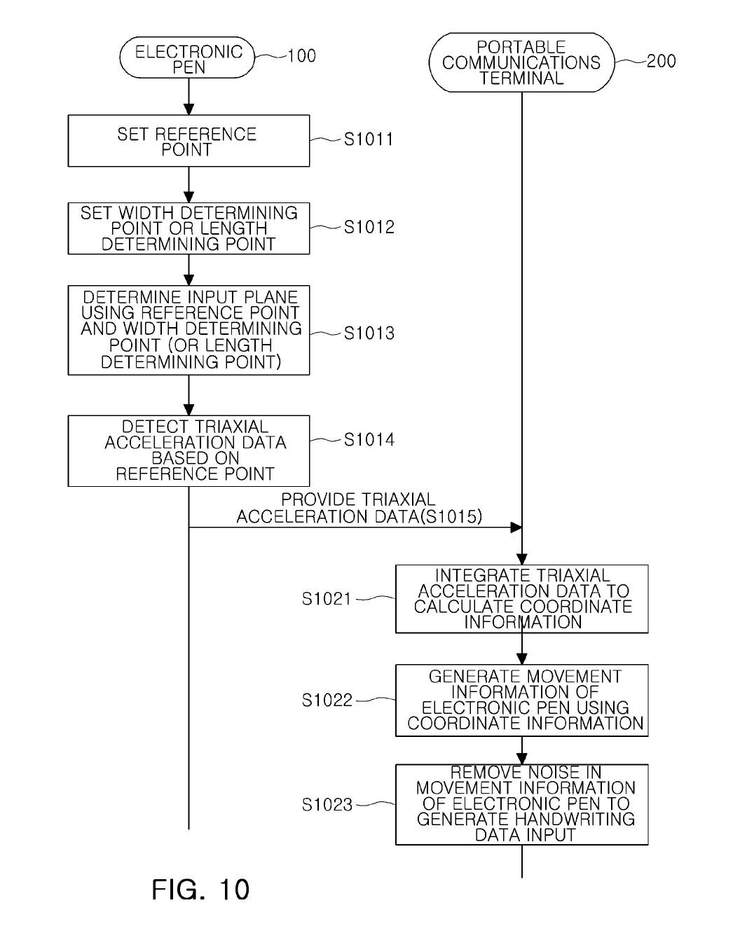

FIG. 8 is a flowchart illustrating an example of an electronic pen data input method according to an embodiment of the present invention; and FIGS. 9 and 10 are flowcharts illustrating other examples of an electronic pen data input method according to the embodiment of the present invention.

Hereinafter, the electronic pen data input method according to the embodiment of the present invention will be described with reference to FIGS. 8 through 10. However, since the electronic pen data input method according to the embodiment of the present invention is performed by the electronic pen 100 and the portable communications terminal 200 described above with reference to FIGS. 4 through 7, overlapping descriptions will be omitted. However, those skilled in the art will clearly understand the electronic pen data input method according to the embodiment of the present invention from the above-mentioned descriptions.

FIG. 8 is a flowchart illustrating an example of an electronic pen data input method according to the embodiment of the present invention.

Referring to FIG. 8, the electronic pen data input method includes setting a reference point (S810), detecting triaxial acceleration data based on the reference point (S820), and generating a handwriting data input according to movement of the electronic pen 100 using the detected triaxial acceleration data (S830).

Here, operations S810 and S820 may be performed by the electronic pen 100. However, operation S830 may be performed by the electronic pen 100 itself or be performed by the portable communications terminal 200.

FIG. 9 is a flowchart illustrating another example of the electronic pen data input method.

Referring to FIG. 9, the electronic pen 100 may set a reference point (S911) and detect triaxial acceleration data based on the reference point (S912).

The electronic pen 100 may provide the triaxial acceleration data to the portable communications terminal 200 (S913).

The portable communications terminal 200 may integrate the triaxial acceleration data to calculate coordinate information (S921) and generates movement information of the electronic pen 100 using the calculated coordinate information (S922).

The portable communications terminal 200 may remove noise in the movement information of the electronic pen 100 to generate a handwriting data input (S923).

FIG. 10 is a flowchart illustrating another example of the electronic pen data input method. In another example of FIG. 10, the above-mentioned ratio determining point (the width determining point or the length determining point) is used.

Referring to FIGS. 10 and 11, the electronic pen 100 may set a reference point P1 (S1011) and set a width determining point P2 or a length determining point P3 (S1012).

The electronic pen 100 may determine an input plane using the reference point and the ratio determining point (S1013) and detect triaxial acceleration data based on the reference point (S1014).

The electronic pen 100 may provide the triaxial acceleration data to the portable communications terminal (S1015).

The portable communications terminal 200 may integrate the triaxial acceleration data to calculate coordinate information (S1021) and generates movement information of the electronic pen 100 using the calculated coordinate information (S1022).

The portable communications terminal 200 may remove noise in the movement information of the electronic pen 100 to generate a handwriting data input (S1023).

The portable communications terminal 200 may reflect a ratio between sizes of the input plane and the display unit 250 to display a handwriting data input. As an example, in the case in which the portable communications terminal receives the reference point P1 and the width determining point P2, it may allow a distance between the reference point P1 and the width determining point P2 to correspond to the width 250r of the display unit 250. As another example, in the case in which the portable communications terminal receives the reference point P1 and the length determining point P3, it may allow a distance between the reference point P1 and the length determining point P3 to correspond to a length 250c of the display unit 250.

As set forth above, according to embodiments of the present invention, an electronic pen having a simplified configuration using an accelerometer sensor is used, whereby portability thereof may be improved and a data input may be performed without touching a portable communications terminal.

While the present invention has been shown and described in connection with the embodiments, it will be apparent to those skilled in the art that modifications and variations can be made without departing from the spirit and scope of the invention as defined by the appended claims.

What is claimed is:

1. An electronic pen data input system comprising:
an electronic pen including an accelerometer sensor to provide acceleration information corresponding to movement thereof; and
a portable communications terminal calculating movement information of the electronic pen using the acceleration information of the electronic pen and compensating for a noise input in the movement information to determine a handwriting data input.

2. The electronic pen data input system of claim 1, wherein the electronic pen includes:
a triaxial accelerometer sensor sensing a change in acceleration based on triaxial coordinates of the electronic pen; and
a controlling unit setting a reference point represented by the triaxial coordinates and generating the acceleration information using the change in acceleration sensed by the triaxial accelerometer sensor due to the movement of the electronic pen.

3. The electronic pen data input system of claim 2, wherein the controlling unit allows information regarding the reference point to be included in the acceleration information and provides the acceleration information to the portable communications terminal.

4. The electronic pen data input system of claim 2, wherein the electronic pen further includes a switching unit sensing an external pressing input, and
the controlling unit generates the acceleration information when the pressing input is sensed by the switching unit.

5. The electronic pen data input system of claim 2, wherein the electronic pen further includes a pressure-sensitive sensor disposed at one end thereof and sensing an amount of pressure provided from the outside, and
the controlling unit generates the acceleration information when pressure of a threshold value or more is sensed by the pressure-sensitive sensor.

6. The electronic pen data input system of claim 1, wherein the portable communications terminal integrates the acceleration information provided from the electronic pen to calculate a movement path of the electronic pen.

7. The electronic pen data input system of claim 2, wherein the portable communications terminal allows a specific position of a display unit thereof to correspond to the reference point to thereby determine the handwriting data input.

8. The electronic pen data input system of claim 7, wherein the portable communications terminal receives the reference point and a ratio determining point from the electronic pen and allows a relationship between the reference point and the ratio determining point to correspond to a portion of a size of the display unit of the portable communications terminal to thereby determine an output ratio of the handwriting data input.

9. An electronic pen data input method performed by an electronic pen including an accelerometer sensor and interworking with a portable communications terminal to generate a handwriting data input, the electronic pen data input method comprising:
setting a reference point;
detecting a change in acceleration on triaxial coordinates based on the set reference point; and
generating acceleration information including the change in acceleration and information regarding the reference point.

10. The electronic pen data input method of claim 9, wherein the generating of the acceleration information includes generating the acceleration information from the change in acceleration when a predetermined amount of pressure is sensed from the outside.

11. The electronic pen data input method of claim 9, further comprising integrating the generated acceleration information to calculate movement information of the electronic pen.

12. The electronic pen data input method of claim 11, further comprising compensating for noise information in the generated movement information to determine the handwriting data input.

13. An electronic pen data input method performed by a portable communications terminal interworking with an electronic pen including an accelerometer sensor to generate a handwriting data input, the electronic pen data input method comprising:
receiving information regarding a reference point represented by triaxial coordinates and acceleration information from the electronic pen;
determining the handwriting data input generated by movement of the electronic pen using the acceleration information; and
displaying the handwriting data input by allowing a specific position of a display unit of the portable communications terminal to correspond to the reference point.

14. The electronic pen data input method of claim 13, wherein the determining of the handwriting data input includes:
integrating the acceleration information to calculate a movement path of the electronic pen; and
compensating for a noise input in the calculated movement information to determine the handwriting data input.

15. The electronic pen data input method of claim 14, wherein the compensating of the noise input includes determining the acceleration information, in which a coordinate value corresponding to a height in the triaxial coordinates is equal to or greater than a threshold value, as the noise input.

16. The electronic pen data input method of claim 13, wherein the displaying of the handwriting data input includes:
receiving a ratio determining point represented by the triaxial coordinates from the electronic pen; and
determining the handwriting data input by allowing a relationship between the reference point and the ratio determining point to correspond to a portion of a size of the display unit of the portable communications terminal.

17. The electronic pen data input method of claim 16, wherein the determining of the handwriting data input includes:
determining a display ratio by allowing a distance between the reference point and the ratio determining point to correspond to a portion of a length of the display unit of the portable communications terminal; and
determining the handwriting data input by reflecting the determined display ratio.
